(19) United States
(12) Patent Application Publication
(10) Pub. No.: US 2025/0371819 A1
(43) Pub. Date: Dec. 4, 2025

(54) METHOD, APPARATUS, DEVICE AND MEDIUM FOR SWITCHING SCENARIOS

(71) Applicant: Beijing Zitiao Network Technology Co., Ltd., Beijing (CN)

(72) Inventor: Junsheng Wu, Beijing (CN)

(21) Appl. No.: 19/220,526

(22) Filed: May 28, 2025

(30) Foreign Application Priority Data
May 29, 2024 (CN) 202410683427.X

(51) Int. Cl. G06T 19/00; G06T 7/70

(52) U.S. Cl. CPC G06T 19/006; G06T 7/70; G06T 2200/24

(57) ABSTRACT

According to an embodiment of the invention, a method, an apparatus, a device and a medium for switching scenarios are provided. The method includes obtaining a first scenario view of a first scenario and a second scenario view of a second scenario, respectively; presenting a scenario switching entry at a client device; and presenting the first scenario in an area outside the scenario switching entry, and presenting the second scenario in an area within the scenario switching entry. This may improve the interactivity between the user and the virtual scenario, and enrich the interaction manner between the user and the virtual scenario.

### CROSS-REFERENCE

This application claims the benefit of Chinese Patent Application No. 202410683427.X entitled “METHOD, APPARATUS, DEVICE AND MEDIUM FOR SWITCHING SCENARIOS” filed on May 29, 2024, the entire content of which is incorporated herein by reference.

### FIELD

Example implementations of the present disclosure generally relate to the field of computers, and in particular, to a method, an apparatus, a device, and a computer-readable storage media for switching scenarios.

### BACKGROUND

With the development of computer technologies, a wide variety of applications have been developed. For example, applications with augmented reality (AR) functionality may be developed. The AR technology is a technology for fusing virtual information and real physical scenarios, and various technical means such as multimedia, three-dimensional modeling, real-time tracking and registration, intelligent interaction and sensing are widely used. The AR technology can apply the generated virtual information to a real physical scenario, and the two types of information are complementary to each other, thereby “enhancing” the real physical scenario.

### SUMMARY

In a first aspect of the present disclosure, a method for switching scenarios is provided. The method comprises obtaining a first scenario view of a first scenario and a second scenario view of a second scenario, respectively; presenting a scenario switching entry at a client device; and presenting the first scenario in an area outside the scenario switching entry, and presenting the second scenario in an area within the scenario switching entry.

In a second aspect of the present disclosure, an apparatus for switching scenarios is provided. The apparatus includes: a scenario view obtaining module configured to obtain a first scenario view of a first scenario and a second scenario view of a second scenario, respectively; a switching entry presentation module configured to present a scenario switching entry at a client device; and a scenario presentation module configured to present the first scenario in an area outside the scenario switching entry, and present the second scenario in an area within the scenario switching entry.

In a third aspect of the present disclosure, an electronic device is provided. The electronic device includes: at least one processor; and at least one memory coupled to the at least one processor and storing instructions for execution by the at least one processor, the instructions, when executed by the at least one processor, causing the electronic device to perform the method according to the first aspect of the present disclosure.

In a fourth aspect of the present disclosure, there is provided a computer-readable storage medium having stored thereon a computer program which, when executed by a processor, causes the processor to implement the method according to the first aspect of the present disclosure.

According to a fifth aspect of the present disclosure, there is provided a computer program product, comprising a computer program, wherein the computer program, when executed by a processor, implements the method according to the first aspect of the present disclosure.

It should be understood that the content described in this disclosure is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIGS. 2A-2C illustrate schematic diagrams of examples in accordance with some embodiments of the present disclosure;

FIG. 3 illustrates a schematic diagram of an example page according to some embodiments of the present disclosure;

FIG. 4 illustrates a schematic view of an example view cone according to some embodiments of the present disclosure;

FIG. 5 shows a flowchart of a process for switching a scenario according to some embodiments of the present disclosure;

FIG. 6 is a schematic structural block diagram of an apparatus for switching a scenario according to some embodiments of the present disclosure; and

FIG. 7 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

In the description of embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. The terms “first,” “second,” and the like may refer to different or identical objects. Other explicit and implicit definitions may also be included below.

Herein, unless explicitly stated, “responding to A” performs one step and does not imply that this step is performed immediately after “A”, but may include one or more intermediate steps.

Herein, the term “virtual environment” may include, but is not limited to, a game environment, a simulation environment, an analog environment, a virtual reality environment, an augmented reality environment, etc., embodiments of the present disclosure are not limited in this respect. For ease of description, only the game environment will be described as an example of the virtual environment.

It may be understood that the data involved in the technical solution (including but not limited to the data itself, the obtaining or use of the data) should follow the requirements of the corresponding laws and regulations and related regulations.

It can be understood that, before the technical solutions disclosed in embodiments of the present disclosure are used, the types of personal information related to the present disclosure, the usage scope, the usage scenario and the like should be notified to the user in an appropriate manner according to the relevant laws and regulations, and the authorization of the user is obtained.

For example, in response to receiving an active request from a user, prompt information is sent to the user to explicitly prompt the user that the requested operation will need to obtain and use personal information of the user, so that the user can autonomously select whether to provide personal information to software or hardware, such as an electric device, an application program, a sever, or a storage medium, etc., executing the operation of the technical solution of the present disclosure according to the prompt information.

As an optional but non-limiting implementation, in response to receiving an active request of a user, a manner of sending prompt information to the user may be, for example, a pop-up window, and prompt information may be presented in a text manner in the pop-up window. In addition, the pop-up window may further carry a selection control for the user to select “agree” or “disagree” to provide personal information to the electronic device.

It may be understood that the foregoing notification and process for obtaining a user authorization are merely illustrative, and do not constitute a limitation on implementations of the present disclosure, and other manners of meeting related laws and regulations may also be applied to implementations of the present disclosure.

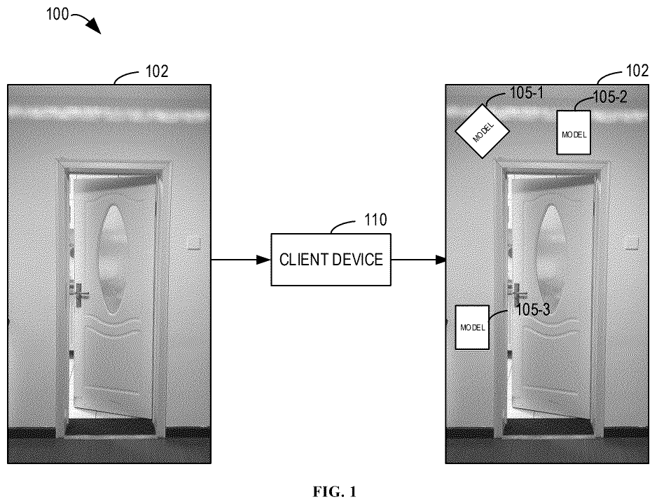

FIG. 1 illustrates a schematic diagram of an example environment 100 in which embodiments of the present disclosure can be implemented. The environment 100 may relate to a client device 110. The client device 110 may also be referred to simply as a client 110.

The client device 110 may capture images or videos of the physical scenario (hereinafter collectively referred to as video data of the physical scenario). The client device 110 may, for example, present a respective presentation page and present the captured video data in the presentation page. For example, the client device 110 may present an image 102 of a physical scenario.

In some embodiments, the client device 110 may be deployed with an application with AR functionality. Where the application is in an active state, the client device 110 may also overlay one or more virtual environment models in an image used to present the physical scenario. For example, the client device 110 may overlay at least one virtual environment model 105 (e.g., may include models 105-1, 105-2, 105-3, etc.) in an image 102. The virtual environment model may include a virtual object (e.g., a virtual ornament on a wall, etc.), virtual information, etc. For another example, if the image includes an object A, the virtual environment model may include, for example, commentary information for the object A.

The client device 110 device may be any type of mobile terminal, fixed terminal, or portable terminal, including a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, including accessories and peripherals of these devices, or any combination thereof. In some embodiments, the client device 110 can also support any type of interface for a user (such as a “wearable” circuit, etc.). The server may be various types of computing systems/servers capable of providing computing power, including, but not limited to, mainframes, edge computing nodes, computing devices in a cloud environment, and the like.

It should be understood that structures and functions of the various elements in the environment 100 are described for example purposes only and do not imply any limitation to the scope of the present disclosure. Traditionally, a client device of an AR enabled application may present a virtual environment to a user. The user may switch between the real environment and the virtual environment using a predetermined control. At this time, the switching process is hard and the sense of disconnection between the virtual environment and the real environment is strong, resulting in lower user immersion.

In view of this, embodiments of the present disclosure provide an improved solution for switching scenarios. According to the solution, a first scenario view of a first scenario and a second scenario view of a second scenario are obtained respectively. A scenario switching entry is presented at a client device. The scenario switching entry may be, for example, a virtual entry model (e.g., a “spatio-temporal portal” model). A first scenario may be presented in an area outside the scenario switching entry and a second scenario may be presented in an area within the scenario switching entry.

In this case, the first scenario may be presented in an area outside the spatio-temporal portal, and the second scenario may be presented in an area within the spatio-temporal portal. Therefore, a scenario switching entry may be provided for the user, and a corresponding scenario view may be presented to the user based on the position where the user is located. This may improve the user's sense of interaction between the user and the virtual scenario, and enrich the interaction manner between the user and the virtual scenario.

Some example embodiments of the present disclosure will be described in detail below with reference to examples of the accompanying drawings. It should be noted that some of the operations described herein with reference to the client device 110 may require assistance of a server to complete. In addition, the operations performed by the client device 110 may be specifically performed by an application running on the client device 110.

The client device 110 may obtain a first scenario view of a first scenario and a second scenario view of a second scenario, respectively. The first scenario herein may be any one of a physical scenario and a virtual scenario, and the second scenario is another one of the physical scenario and the virtual scenario. For example, if the first scenario is a physical scenario, the second scenario is a virtual scenario. If the first scenario is a virtual scenario, the second scenario is a physical scenario.

The client device 110 is located in a physical scenario. The client device 110 may receive a scenario view corresponding to the physical scenario from a collection device (e.g., a camera) associated with the client device 110. For example, if the first scenario is a physical scenario, the client device 110 may receive the first scenario view from a camera associated with the client device in response to determining that the first scenario is a physical scenario. The client device 110 may also generate a scenario view of the virtual scenario based on the virtual scenario and the virtual camera used to view the virtual scenario.

For example, if the first scenario is a virtual scenario, the client device 110 may generate a first scenario view based on the virtual scenario and the virtual camera used to view the virtual scenario in response to determining that the first scenario is a virtual scenario. The position and direction of the virtual camera herein are determined based on the position and direction of the client device 110 in the physical scenario. For example, the position and direction of the virtual camera in the virtual scenario may match the position and direction of the client device 110 in the physical scenario.

The client device 110 may present a scenario switching entry for the first scenario and the second scenario. The scenario switching entry may be, for example, a virtual entry model in a virtual scenario that may be presented at a position that matches a physical area in a physical scenario. In addition to the virtual entry model, the virtual scenario further includes a virtual environment model and a virtual object model, and the virtual object model is located in the virtual environment model. Taking the virtual scenario as a virtual forest as an example, the virtual environment model may be, for example, a sky sphere, and the virtual object model may include, for example, a virtual forest, a virtual animal, or the like.

This virtual environment model may be generated by the client device 110 based on user input. Specifically, the client device 110 may present an input control for inputting a description for the virtual environment model, the input control being used to input text or an image. For example, the client device 110 may present a generated page of the virtual environment model, and present the input control in the generated page. The input control may be, for example, an input box. The input control may include, for example, an input control of the text, an input control of the voice, an input control of the image, and the like.

The client device 110 may, in turn, generate a virtual environment model in response to an input interaction for the input control. For example, the client device 110 may receive user input via an input control, which may include text, images, audio, and the like. The client device 110 may convert audio to corresponding text, for example. The client device 110 may determine a description of the virtual environment and generate a corresponding prompt word based on the received text, the converted text, the received image, and/or the like. The client device 110 may in turn invoke a machine learning model (e.g., a language model) to generate a texture of the virtual environment model based on the prompt words.

The client device 110 may generate the virtual environment model in any suitable manner. For example, the client device 110 may only generate a virtual environment model (e.g., a sky sphere model) based on any suitable rules or algorithms, thereby mapping the generated textures to the sky sphere, thereby generating a complete sky sphere model. As another example, the client device 110 may also utilize the trained machine learning model to generate a virtual environment model.

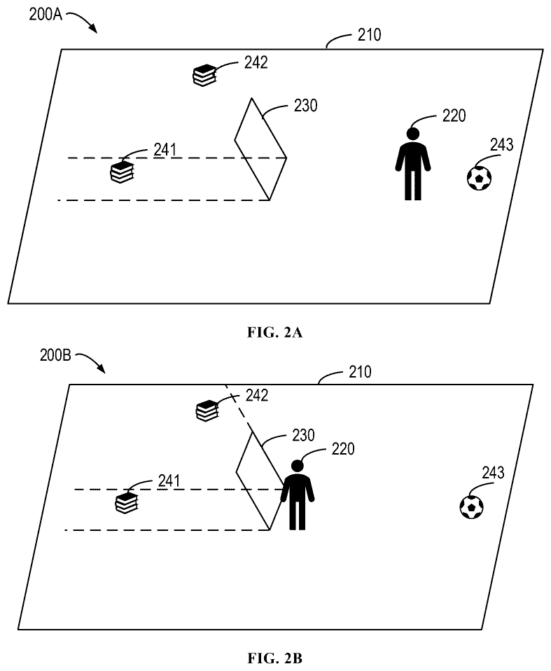

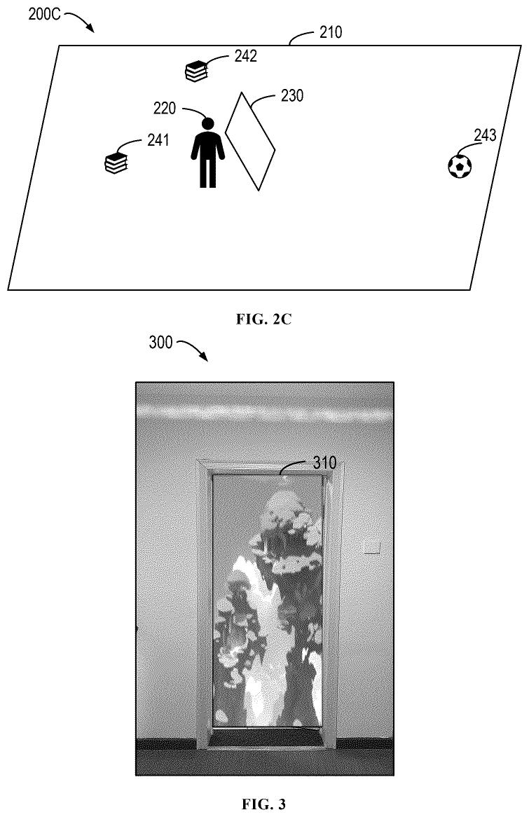

The client device 110 may present a first scenario in an area outside the scenario switching entry and a second scenario in an area within the scenario switching entry. Specific examples of scenario presentation are described below with reference to FIGS. 2A-2C, which illustrate diagrams of examples 200A-200C in accordance with some embodiments of the present disclosure. The physical scenario 210 may, for example, be in a real physical space (e.g., a room, an office, a stairwell, etc.). The user 220 is in the physical scenario 210, and the client device 110 may be, for example, a terminal device of the user 220. Herein, an example in which the position of the client device 110 and the position where the user 220 is located is used as an example for description.

In example 200A, if the user 220 captures the left side, the client device 110 may capture a scenario view of the physical scenario on the left side of the user 220 using the camera. The client device 110 may present a scenario switching entry. Note that the scenario switching entry does not really exist in the physical scenario, but rather is presented in a virtual model that matches the position of the physical area 230 in the physical scenario 210. The client device 110 may present, for example, an example page 300 as shown in FIG. 3 to a user. FIG. 3 illustrates a schematic diagram of an example page 300 according to some embodiments of the present disclosure. Taking the physical scenario 210 as a room as an example, the example page 300 may, for example, present a scenario switching entry 310, and present a virtual scenario in the scenario switching entry 310, and present a physical scenario outside the scenario switching entry.

In some embodiments, the client device 110 may load the virtual scenario in response to determining that the direction of the virtual camera is the same as the direction from the position of the virtual camera to the position of the virtual entry model, and the distance between the position of the virtual camera and the position of the virtual entry model is lower than the threshold distance. The direction of the virtual camera and the position of the virtual camera herein are also the direction and the position of the client device 110.

As shown in FIG. 2A and FIG. 2B, if the user 220 moves from the position where the example 200A is located to the position in the example 200B, and the direction of the client device 110 of the user 220 is leftward, the direction of the virtual camera is the same as the direction from the position of the virtual camera to the position of the virtual entry model. In this case, it may be considered that the user 220 approaches the virtual entry model in the physical scenario 210 (that is, the user 220 gradually approaches the virtual scenario).

The action of the user 220 from the right to the left close to the virtual entry model may be considered as the distance between the position of the user 220 and the position of the virtual entry model being positive and decreasing gradually. If the position of the user 220 overlaps with the position of the virtual entry model, it may be considered that the distance between the position of the user 220 and the position of the virtual entry model is 0. If the user 220 continues to move to the left, it may be considered that the distance between the position of the user 220 and the position of the virtual entry model is negative.

For example, as shown in FIG. 2C, if the user moves to the position where the example 200C is located, it may be determined that the user 220 is located on the left side of the virtual entry model, and it may be considered that the distance between the position of the user 220 and the position of the virtual entry model is a negative number.

In some embodiments, the threshold distance may be set to 0.5 m (or other numerical value). If the distance between the position of the user 220 and the position of the virtual entry model is lower than the threshold distance, the client device 110 may load the virtual scenario and present the virtual scenario to the user 220. For example, if the user 220 is in the position shown in example 200B, as the user 220 gradually moves to the left, the distance between the position of the user 220 and the position of the virtual entry model gradually decreases and is lower than 0.5 m, the client device 110 may load the virtual scenario. In this case, if the user 110 continuously moves to the left and reaches the position shown in FIG. 2C, the client device 110 may consider that the user is in a virtual scenario, the client device 110 presents a physical scenario in the scenario switching entry 310, and presents the virtual environment outside the scenario switching entry.

Note that in examples 200A-200C, physical scenarios 210 may include real objects 241, 242, and 243. In example 200A, since the position of the scenario switching entry is located on the right side of the object 241, the user 220 is located on the right side of the scenario switching entry, and the client device 110 only presents the scenario switching entry for the page presented by the user, and does not need to present the content blocked by the scenario switching entry (for example, the object 241). Similarly, in the example 200B, the client device 110 only presents the scenario switching entry for the page presented by the user, and does not need to present content that is blocked by the scenario switching entry (for example, the object 241 and the object 242). In example 200C, if the gaze direction of the user 220 is to the right and the user 220 is considered to be in the virtual scenario at this time, the client device 110 presents a scenario view including the physical scenario 210 of the object 243 for the area within the scenario switching entry presented by the user, that is, presents the object 243.

In some embodiments, the client device 110 may also unload the virtual scenario in response to determining that the direction of the virtual camera is opposite to the direction from the position of the virtual camera to the position of the virtual entry model. Similarly, the direction of the virtual camera and the position of the virtual camera are also the direction and position of the client device 110.

As shown in FIG. 2A to FIG. 2C, taking the position of the user 220 as the position shown in the example 200C as an example, if the direction of the client device 110 of the user 220 is leftward, the direction of the user 220 itself may be the leftward direction, and the user 220 is in a reverse state (for example, moving back to the position shown in the example 200B or the position shown in the example 200A). At this time, the direction from the position of the virtual camera to the position of the virtual entry model is rightward. The client device 110 may be considered that the user 220 approaches the virtual entry model in the virtual environment (that is, the user 220 gradually leaves the virtual scenario), and the client device 110 may unload the virtual scenario. The client device 110 may, for example, continue to present the example page as shown in FIG. 3.

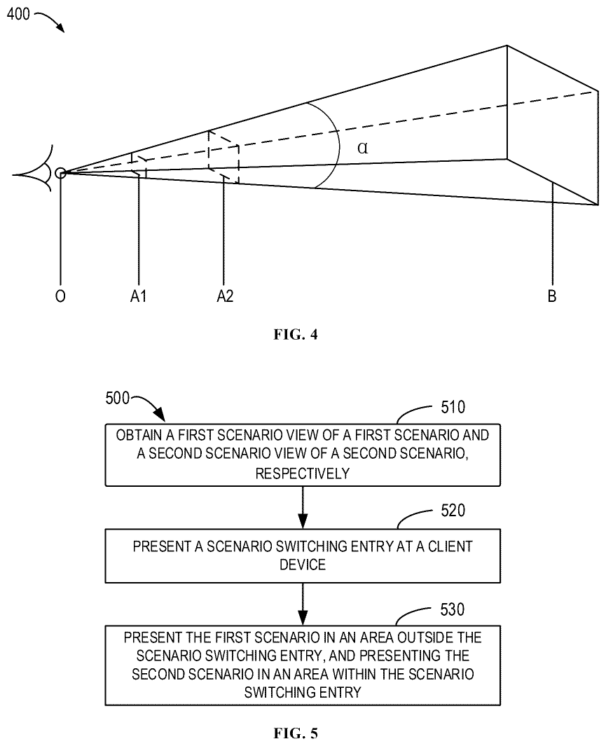

It should be understood that in the scenario switching process, due to improper parameter setting of the virtual camera, a splash screen problem may occur. Regarding the parameters of the virtual camera, in some embodiments, the client device 110 may set a near plane parameter of the virtual camera in response to determining that the direction of the virtual camera points to the virtual entry model, thereby eliminating the product problem. Referring to FIG. 4, FIG. 4 shows a schematic diagram of an example view cone 400 (which may also be referred to as example 400 for short) according to some embodiments of the present disclosure. The example 400 takes the client device 110 at the position O as an example, because the client device 110 is configured to present a scenario view for the user, or may be considered that the position of the human eye is at position O.

At this time, the scenario view obtained by the virtual camera corresponding to the client device 110 is the content between the near plane and the far plane of the view cone shown in example 400. The far plane may, for example, be located at position B shown in example 400. The view angle of the view cone may be, for example, the angle α shown in the figure. It should be noted that the content obtained by the virtual camera is content in the middle of the near plane to the far plane. Therefore, the richness of the virtual camera obtaining the content when the near plane is at the position A1 is greater than the richness of the virtual camera obtaining the content when the near plane is located at the position A2.

If the position of the near plane is close to the position O, the virtual camera may obtain the richer content of the virtual scenario, and the client device 110 may set the near plane position to a smaller value in advance when the virtual scenario is loaded, which may reduce the distortion feeling of presenting the virtual scenario and enhance the sense of the user's sense of entering the virtual scenario. Specifically, the client device 110 may set a near plane, for example, a distance of 0.001 m, that is closer to the position (that is, the position where the virtual camera is located) where the virtual camera is located.

Specifically, the client device 110 may obtain a projection matrix of the virtual camera, and extract the far plane parameter and the field-of-view parameter of the virtual camera from the projection matrix. The client device 110 may in turn update the projection matrix based on the predetermined near plane parameter, the far plane parameter, and the field-of-view parameter. For example, the client device 110 may obtain a projection matrix of the virtual camera:

$$M = [ \begin{matrix}m 0 & m 1 & m 2 & m 3 \\ m 4 & m 5 & m 6 & m 7 \\ m 8 & m 9 & m 10 & m 11 \\ m 12 & m 13 & m 14 & m 15\end{matrix} ]$$

Here, M represents a matrix of 4 * 4 dimensions, and m0 to m15 in the matrix may be appropriately set values. The client device 110 may determine the far plane parameter far and the field-of-view parameter fov based on various parameters, such as 16 parameters of the above matrix, in this matrix. The client device 110 saves the far plane parameter far and the field-of-view parameter fov. The client device 110 may in turn determine a closer near plane and determine a smaller near plane parameter (e.g., determine near′=0.001). The client device 110 may further calculate to derive a new projection matrix (that is, update the projection matrix by using the predetermined near plane parameter, the far plane parameter, and the field-of-view parameter) based on the determined smaller near plane parameter near′ (i.e., the predetermined near plane parameter), the far plane parameter far, and the field-of-view parameter fov.

It should be understood that while the above discussion of “spatio-temporal portal” describes presenting a spatio-temporal portal at a position of gate in a physical scenario. Alternatively and/or additionally, the switching entry may be presented at some specific coordinate in the physical space. For example, a virtual television screen may be presented at a room central position, and a user may switch to a virtual scenario through the virtual television screen. For another example, a virtual mobile phone screen may be presented on a desktop, and a user may switch to a virtual scenario through the virtual television screen, and so on.

In summary, according to embodiments of the present disclosure, a scenario switching entry may be provided for a user, and a scenario view may be presented to the user based on the position where the user is located. This may improve the interaction feeling between the user and the virtual scenario, and enrich the interaction manner between the user and the virtual scenario.

FIG. 5 shows a flowchart of a process 500 for switching scenarios according to some embodiments of the present disclosure. The process 500 may be implemented at the client device 110. The process 500 is described below with reference to FIG. 1.

At block 510, a first scenario view of a first scenario and a second scenario view of a second scenario are obtained, respectively.

At block 520, a scenario switching entry is presented at the client device 110.

At block 530, a first scenario is presented in an area outside the scenario switching entry and a second scenario is presented in an area within the scenario switching entry.

In some embodiments, the first scenario is any of a physical scenario and a virtual scenario, and the second scenario is another one of a physical scenario and a virtual scenario.

In some embodiments, the client device is located in a physical scenario, the scenario switching entry is a virtual entry model in a virtual scenario, and the virtual entry model is presented at a position matching the physical area in the physical scenario.

In some embodiments, the obtaining the first scenario view includes: in response to determining that the first scenario is a virtual scenario, generating a first scenario view based on the virtual scenario and a virtual camera for viewing the virtual scenario.

In some embodiments, a position and a direction of the virtual camera are determined based on a position and a direction of the client device in the physical scenario, respectively.

In some embodiments, the virtual scenario comprises a virtual environment model and a virtual object model, the virtual object model is located in the virtual environment model, and the process 500 further comprises: presenting an input control for inputting a description for the virtual environment model, the input control being configured to input a text or an image; and in response to an input interaction for the input control, generating a virtual environment model.

In some embodiments, the process 500 further includes setting a near plane parameter of the virtual camera in response to determining that the direction of the virtual camera points to the virtual entry model.

In some embodiments, setting the near plane parameter of the virtual camera includes: obtaining a projection matrix of the virtual camera; extracting a far plane parameter and a field-of-view parameter of the virtual camera from the projection matrix; and updating the projection matrix based on the predetermined near plane parameter, the far plane parameter, and the field-of-view parameter.

In some embodiments, the process 500 further includes loading the virtual scenario in response to determining that a direction of the virtual camera is the same as a direction from a position of the virtual camera to a position of the virtual entry model, and a distance between the position of the virtual camera and the position of the virtual entry model being lower than the threshold distance.

In some embodiments, the process 500 further includes, in response to determining that the direction of the virtual camera is opposite to the direction from the position of the virtual camera to the position of the virtual entry model, unloading the virtual scenario.

In some embodiments, the obtaining the first scenario view includes: in response to determining that the first scenario is a physical scenario, receiving the first scenario view from a collection device associated with the client device.

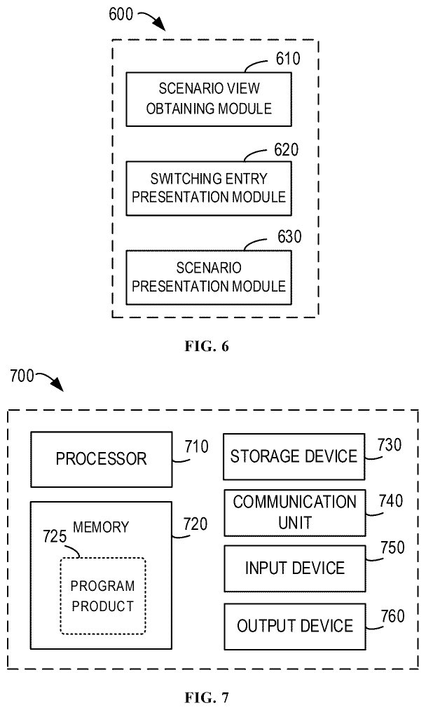

Embodiments of the present disclosure also provide a corresponding apparatus for implementing the above method or process. FIG. 6 is a schematic structural block diagram of an apparatus 600 for switching scenarios according to some embodiments of the present disclosure. The various modules/components in the apparatus 600 may be implemented by hardware, software, firmware, or any combination thereof.

As shown, the apparatus 600 includes a scenario view obtaining module 610 configured to acquire a first scenario view of a first scenario and a second scenario view of a second scenario, respectively. The apparatus 600 further includes a switching entry presentation module 620 configured to present the scenario switching entry at the client device. The apparatus 600 further includes a scenario presentation module 630 configured to present a first scenario in an area outside the scenario switching entry and a second scenario in an area within the scenario switching entry.

In some embodiments, the first scenario is any of a physical scenario and a virtual scenario, and the second scenario is another one of a physical scenario and a virtual scenario.

In some embodiments, the client device is located in a physical scenario, the scenario switching entry is a virtual entry model in a virtual scenario, and the virtual entry model is presented at a position matching the physical area in the physical scenario.

In some embodiments, the scenario view obtaining module 610 includes: a first view generating module configured to generate a first scenario view based on the virtual scenario and a virtual camera for viewing the virtual scenario in response to determining that the first scenario is a virtual scenario.

In some embodiments, a position and a direction of the virtual camera are determined based on a position and a direction of the client device in the physical scenario, respectively.

In some embodiments, the virtual scenario includes a virtual environment model and a virtual object model, the virtual object model is located in the virtual environment model, and the apparatus 600 further includes: an input control presentation module configured to present an input control for inputting a description for the virtual environment model, the input control being configured to input a text or an image; and a model generation module configured to generate a virtual environment model in response to an input interaction for the input control.

In some embodiments, the apparatus 600 further includes: a parameter setting module configured to set a near plane parameter of the virtual camera in response to determining that the direction of the virtual camera points to the virtual entry model.

In some embodiments, the parameter setting module includes: a projection matrix obtaining module configured to obtain a projection matrix of the virtual camera; a parameter extraction module configured to extract a far plane parameter and a field-of-view parameter of the virtual camera from the projection matrix; and a projection matrix updating module configured to update the projection matrix based on the predetermined near plane parameter, the far plane parameter, and the field-of-view parameter.

In some embodiments, the apparatus 600 further includes: a virtual scenario loading module configured to load the virtual scenario in response to determining that the direction of the virtual camera is the same as the direction from the position of the virtual camera to the position of the virtual entry model, and the distance between the position of the virtual camera and the position of the virtual entry model is lower than a threshold distance.

In some embodiments, the apparatus 600 further includes a virtual scenario unloading module configured to unload the virtual scenario in response to determining that the direction of the virtual camera is opposite to the direction from the position of the virtual camera to the position of the virtual entry model.

In some embodiments, the scenario view obtaining module 610 includes: a view receiving module configured to receive a first scenario view from a collection device associated with the client device in response to determining that the first scenario is a physical scenario.

The units and/or modules included in the apparatus 600 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 600 may be implemented, at least in part, by one or more hardware logic components. By way of example and not limitation, exemplary types of hardware logic components that may be used include field programmable gate arrays (FPGAs), application specific integrated circuits (ASICs), application specific standard products (ASSPs), system-on-a-chip (SOCs), complex programmable logic devices (CPLDs), and the like.

It should be understood that one or more of the above methods may be performed by a suitable electronic device or a combination of electronic devices. Such electronic devices or combinations of electronic devices may include, for example, client device 110 in FIG. 1.

FIG. 7 illustrates a block diagram of an electronic device 700 in which one or more embodiments of the present disclosure may be implemented. It should be understood that the electronic device 700 illustrated in FIG. 7 is merely exemplary and should not constitute any limitation on the functionality and scope of embodiments described herein. The electronic device 700 shown in FIG. 7 may be configured to implement the client device 110 of FIG. 1 and/or the apparatus 600 of FIG. 6.

As shown in FIG. 7, the electronic device 700 is in the form of a general-purpose electronic device. Components of the electronic device 700 may include, but are not limited to, one or more processors or processors 710, a memory 720, a storage device 730, one or more communication units 740, one or more input devices 750, and one or more output devices 760. The processor 710 may be an actual or virtual processor and capable of performing various processes according to programs stored in the memory 720. In multiprocessor systems, multiple processors execute computer-executable instructions in parallel to improve parallel processing capabilities of electronic device 700.

The electronic device 700 typically includes a plurality of computer storage media. Such media may be any available media accessible to the electronic device 700, including, but not limited to, a volatile and non-volatile media, a removable and non-removable media. The memory 720 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 is configured to communicate with another electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, external devices such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for switching scenarios, comprising:
obtaining a first scenario view of a first scenario and a second scenario view of a second scenario, respectively;
presenting a scenario switching entry at a client device; and
presenting the first scenario in an area outside the scenario switching entry, and presenting the second scenario in an area within the scenario switching entry.

2. The method of claim 1, wherein the first scenario is any of a physical scenario and a virtual scenario, and the second scenario is another of the physical scenario and the virtual scenario.

3. The method of claim 2, wherein the client device is located in the physical scenario, the scenario switching entry is a virtual entry model in the virtual scenario, and the virtual entry model is presented at a position matching a physical area in the physical scenario.

4. The method of claim 3, wherein obtaining the first scenario view comprises: in response to determining that the first scenario is a virtual scenario, generating the first scenario view based on the virtual scenario and a virtual camera for viewing the virtual scenario.

5. The method of claim 4, wherein a position and a direction of the virtual camera are determined based on a position and a direction of the client device in the physical scenario, respectively.

6. The method of claim 4, wherein the virtual scenario comprises a virtual environment model and a virtual object model, the virtual object model is located in the virtual environment model, and the method further comprises:
presenting an input control for inputting a description for the virtual environment model, the input control being configured to input a text or an image; and
generating the virtual environment model in response to an input interaction for the input control.

7. The method of claim 4, further comprising: setting a near plane parameter of the virtual camera in response to determining that the direction of the virtual camera points to the virtual entry model.

8. The method of claim 7, wherein setting the near plane parameter of the virtual camera comprises:
obtaining a projection matrix of the virtual camera;
extracting a far plane parameter and a field-of-view parameter of the virtual camera from the projection matrix; and
updating the projection matrix based on a predetermined near plane parameter, the far plane parameter, and the field-of-view parameter.

9. The method of claim 4, further comprising: in response to determining that a direction of the virtual camera is the same as a direction from a position of the virtual camera to a position of the virtual entry model, and a distance between the position of the virtual camera and the position of the virtual entry model being lower than a threshold distance, loading the virtual scenario.

10. The method of claim 9, further comprising: in response to determining that the direction of the virtual camera is opposite to a direction from a position of the virtual camera to a position of the virtual entry model, unloading the virtual scenario.

11. The method of claim 2, wherein obtaining the first scenario view comprises: in response to determining that the first scenario is a physical scenario, receiving the first scenario view from a collection device associated with the client device.

12. An electronic device, comprising:
at least one processor; and
at least one memory coupled to the at least one processor and storing instructions for execution by the at least one processor, the instructions, when executed by the at least one processor, causing the electronic device to perform:
obtaining a first scenario view of a first scenario and a second scenario view of a second scenario, respectively;
presenting a scenario switching entry at a client device; and
presenting the first scenario in an area outside the scenario switching entry, and presenting the second scenario in an area within the scenario switching entry.

13. The electronic device of claim 12, wherein the first scenario is any of a physical scenario and a virtual scenario, and the second scenario is another of the physical scenario and the virtual scenario.

14. The electronic device of claim 13, wherein the client device is located in the physical scenario, the scenario switching entry is a virtual entry model in the virtual scenario, and the virtual entry model is presented at a position matching a physical area in the physical scenario.

15. The electronic device of claim 14, wherein obtaining the first scenario view comprises: in response to determining that the first scenario is a virtual scenario, generating the first scenario view based on the virtual scenario and a virtual camera for viewing the virtual scenario.

16. The electronic device of claim 15, wherein a position and a direction of the virtual camera are determined based on a position and a direction of the client device in the physical scenario, respectively.

17. The electronic device of claim 15, wherein the virtual scenario comprises a virtual environment model and a virtual object model, the virtual object model is located in the virtual environment model, and the instructions, when executed by the at least one processor, further causing the electronic device to perform:
presenting an input control for inputting a description for the virtual environment model, the input control being configured to input a text or an image; and
generating the virtual environment model in response to an input interaction for the input control.

18. The electronic device of claim 15, wherein the instructions, when executed by the at least one processor, further causing the electronic device to perform: setting a near plane parameter of the virtual camera in response to determining that the direction of the virtual camera points to the virtual entry model.

19. The electronic device of claim 18, wherein setting the near plane parameter of the virtual camera comprises:
obtaining a projection matrix of the virtual camera;
extracting a far plane parameter and a field-of-view parameter of the virtual camera from the projection matrix; and
updating the projection matrix based on a predetermined near plane parameter, the far plane parameter, and the field-of-view parameter.

20. A non-transitory computer-readable storage medium having stored thereon a computer program executable by a processor to implement:
obtaining a first scenario view of a first scenario and a second scenario view of a second scenario, respectively;
presenting a scenario switching entry at a client device; and
presenting the first scenario in an area outside the scenario switching entry, and presenting the second scenario in an area within the scenario switching entry.
